(19) United States
(12) Patent Application Publication
(10) Pub. No.: US 2006/0140357 A1
(43) Pub. Date: Jun. 29, 2006

(54) Graphical tool for creating a call routing application

(75) Inventors: Felipe Gomez, Weston, FL (US); Jeffrey S. Kobal, Lake Worth, FL (US); Brent D. Metz, Delray Beach, FL (US); Rosa Naranjo, Boynton Beach, FL (US)

Correspondence Address: Steven M. Greenberg, Esquire;Christopher & Weisberg, P.A., Suite 2040, 200 East Las Olas Boulevard, Fort Lauderdale, FL, 33301, US

(73) Assignee: International Business Machines Corporation, Armonk, NY (US)

(21) Appl. No.: 11/022,737

(22) Filed: Dec. 27, 2004

(51) Int. Cl. H04M 11/00

(52) U.S. Cl. 379/88.16

(57) ABSTRACT

A method, system and apparatus for graphically managing the development of a dynamic call router. In this regard, a graphical tool for creating a dynamic call router can include a language model engine such as a natural language understanding language model engine, a call routing object coupled to the language model engine and referencing a call route termination object in a canvas, and a call flow palette having one or more call flow elements configured for arrangement in the canvas. The graphical tool further can include at least one statement represented graphically in the canvas.

### BACKGROUND OF THE INVENTION

1. Statement of the Technical Field

The present invention relates to speech systems and more particularly to the configuration of a call routing application.

2. Description of the Related Art

Telephone prompting systems are increasing employed to provide an interface to voicemail systems and to provide an interface for interactive voice response (IVR) systems, such as airline reservations, bank customer account lines, and other institutional lines such those of government, utilities, credit card companies and the like. Many systems, such as those used for banking or stock trading, may be frequently accessed by individual users, often several times a day. In such systems, users are presented with hierarchical levels of prompts that the customer can respond to by depressing buttons on the telephone keypad or through spoken words. The resulting dual tone multi-frequency signals or speech audio received by the prompting system can be used to access a different level in the hierarchy or to access a specified function.

Notably, conventional prompting system technologies do not require two-way human interaction over the telephone as end user interactions with a database can be predetermined by what the prompting system will permit the user to access. For example, banks and credit card companies use prompting systems so that their customers can receive up-to-date account information instantly and easily without having to speak directly to a person. IVR systems also can be used to gather information, as in the case of telephone surveys in which the user is prompted to answer questions by pushing the numbers on a touch-tone telephone.

A call router is the most common of IVR systems, typified by prompting a caller to speak or dial selections for routing the call to a particular destination. Examples include, “Press 1 for billing, press 2 for the warranty department, press 3 for the complaint department.” Thus, a call router provides a spoken menu of choices for routing a call in the IVR system. Once “routed” to the destination, which can include a person or another automated system, a more complex interaction can unfold in order to satisfy the interests of the caller.

Whereas conventional IVR systems generally utilize pre-scripted call routing based upon hard coded prompts, a new trend in call routing has begun to emerge within the speech industry. Dynamic call routers utilize text processing and optionally statistical processes to determine routing based on an open ended ‘How May I Help You?’ style prompt. Examples of dynamic call routers include natural language call routers and finite state grammar call routers, to name two. Unlike static call routers, however, dynamical call routing can be quite complex.

Specifically, the use of a dynamic call router can avoid the long, clunky, confusing list of options of a typical call router, and instead provide the caller with a “How May I Help You?” prompt. Then, if the user says, “My air conditioner broke, and I just bought it last month!”, the system can determine—through a process often referred to as “natural language understanding”, that the customer intends to speak to the warranty department. Alternatively, the dynamic call router can ask the caller, “Do you want the warranty department, or the complaint department?” if the choice of destinations is deemed to be ambiguous.

Due to the complexity of dynamic call routing, the development of a dynamic call router can be performed only by domain experts due to the nuances of handling the output of multiple statistical engines and the lack of any industry standard method of describing the design of such applications. Consequently, one who is interested in creating a dynamic call router typically engages a specialized team whose sole focus is on the design of elegantly handling the output of the statistical engines. The engagement of a specialized team, however, can waste internal technical resources and can result in missed opportunities to mix the call routing statistical engines with directed dialog follow-up or screening questions. Additionally, the use of a specialized team can be expensive and slow.

### SUMMARY OF THE INVENTION

The present invention addresses the deficiencies of the art in respect to dynamic call routing and provides a novel and non-obvious method, system and apparatus for graphically managing the development of a dynamic call router. In this regard, a graphical tool for creating a dynamic call router can include a language model engine such as a natural language understanding language model engine, a call routing object coupled to the language model engine and referencing a call route termination object in a canvas, and a call flow palette having one or more call flow elements configured for arrangement in the canvas. The graphical tool further can include at least one statement represented graphically in the canvas.

In a preferred aspect of the invention, the graphical tool can include a properties view configured to display call routing properties of the call routing object. In particular, the call routing properties can include one or more confirmation and/or disambiguation prompts. The graphical tool further can include a destinations view configured to display available destinations for linkage to the call routing object in a call route termination object.

A method for graphically creating a dynamic call router can include the step of graphically linking a call routing object to a call route termination object in a canvas of a graphical tool for creating dynamic call routers and graphically specifying routing properties for the call routing object. The step of graphically linking can include placing a call routing object in the canvas and identifying at least one call route termination object to which a call is to be routed for a responsive utterance to a prompt associated with the call routing object. Also, the step of graphically specifying routing properties can include specifying at least one of a confirmation prompt for a responsive utterance to an initial prompt provided by the call routing object, and a disambiguation prompt to resolve uncertainties in a selected call route for a responsive utterance to an initial prompt.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a graphical tool configured to create and manage a call routing application;

FIG. 2 is a schematic illustration of a graphical tool configured to create and manage a call routing application; and,

FIG. 3 is a flow chart illustration a process for creating a call routing application in the graphical tool of FIG. 2.

### DETAILED DESCRIPTION OF THE PREFERRED EMBODIMENTS

The present invention is a graphical tool for creating and managing a dynamic call router. In accordance with the present invention, a graphical tool for creating and managing a dynamic call router can include a call flow palette configured to process both call routing objects and call route termination objects. Call routing objects can graphically represent the use of a language model such as a statistical language model to obtain caller utterances and to classify each caller utterance as indicating an intended destination in the call flow.

Call route termination objects, by comparison, route calls to desired destinations. Desired destinations can include separate IVR applications or telephone endpoints, for example. In this way, unique arrangements of call routing objects and call route termination objects can define a dynamic call router. The dynamic call router, once graphically represented, can be reduced to a representative document such as a markup language document. Subsequently, the markup language document can be interpreted and executed in an IVR system as a dynamic call router.

Notably, the graphical tool of the present invention can be used to visualize an application flow through the call routing process in conjunction with typical call flow objects recognized within industry directed dialog graphical design tools. To that end, the graphical tool can be configured to optimize default behavior in a successful route, when confirming a choice with a caller and when disambiguating between route choices with callers. The editor of the graphical tool can operate in conjunction with a view for describing properties of each destination the application and a properties view to describe graphical canvas item properties. Consequently, one of limited or no language processing experience can build a call router using the metaphors most familiar to the user in the graphical call flow creation process.

Hence, by lowering the skill set required to produce a dynamic call router, a broader base of developers can become involved in the call flow generation process. Also, integration possibilities can be enhanced as developers for the destination applications now can more easily collaborate to build a more tightly integrated overall experience for a caller. Of course, utilizing a graphical too can avoid the need to learn a proprietary call flow development language, thereby minimizing work time in the development of an IVR application model rather than the IVR application markup. Thus, future migration paths to other markup sets can be facilitated as can the expansion to more powerful capabilities of runtime technologies.

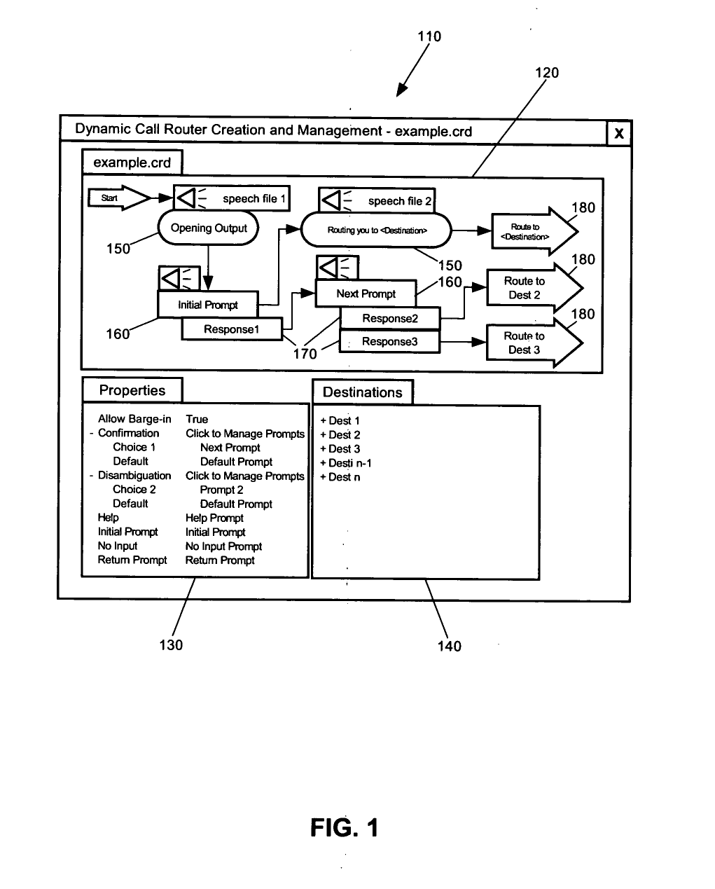

In more particular illustration, FIG. 1 is a pictorial illustration of a graphical tool 110 configured to create and manage a call routing application. The graphical tool 110 can include a canvas 120 in which representative graphical call flow elements can be placed, arranged and associated. The graphical call flow elements can be selected from a call flow pallet and can include selection, connection, start, statement, prompt, decision, comment, confirmation, disconnect and goto objects. For instance, as shown in FIG. 1, representative call flow elements can include statements 150 in addition to call routing objects 160.

Importantly, call routing objects 160 can be configured to perform routing decisions based upon one or more prompt responses 170 interpreted by a language model engine. The routing decisions ultimately can result in the calling of route termination objects 180. In this regard, call routing objects 160 allow the user to define when to override the default behavior of the call router for specific situations based upon the confidence levels of the call routing engines and which destinations where chosen by the engines.

The graphical tool 110 yet further can include a properties view 130 in which the properties of an object in the canvas 120 can be rendered and manipulated, and a destinations view 140 in which one or more destinations for the call route termination objects 180 can be manipulated. Notably, the properties view 130 for the call routing objects can link to dialogs for designing confirmation prompts to confirm the language model engine outputs from the caller where the engine is able to identify an intended destination, but where the engine lacks enough confidence to automatically select the identified destination.

Dialogs further can be linked for designing disambiguation prompts to allow callers to disambiguate between two or more destinations when the language model engine cannot decide which destination would be the most appropriate destination to which to route the caller. Reasonable default values for the destination also can be edited which can be automatically added to the IVR application for use in generic dialogs. Yet, overrides can be added through the dialogs to handle confirmation or disambiguation prompts for specific destinations and pairs of destinations, respectively. Statistical engine thresholds for the defaults and for each configured confirmation or destination prompt can be modified further, thereby allowing the fine tuning of the representation of an ambiguity.

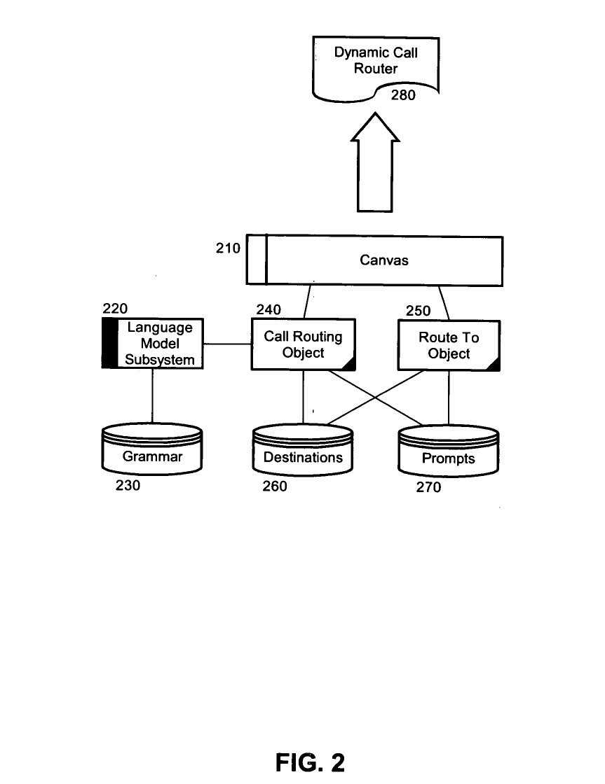

In further illustration, FIG. 2 is a schematic illustration of a graphical tool configured to create and manage a call routing application. The graphical tool can include a canvas 210 coupled to one or more call routing objects 240 and one or more call route termination objects 250, also referred to as “route to” objects. Both the call routing objects 240 and call route termination objects 250 can be coupled to both a listing of destinations 260 and a listing of prompts 270. In this regard, each of the call routing objects 240 can define a route to another of the call routing objects 240 or one of the call route termination objects 250 based upon an interpretation of prompt responses provided by the language model subsystem 220 based upon an underlying grammar 230.

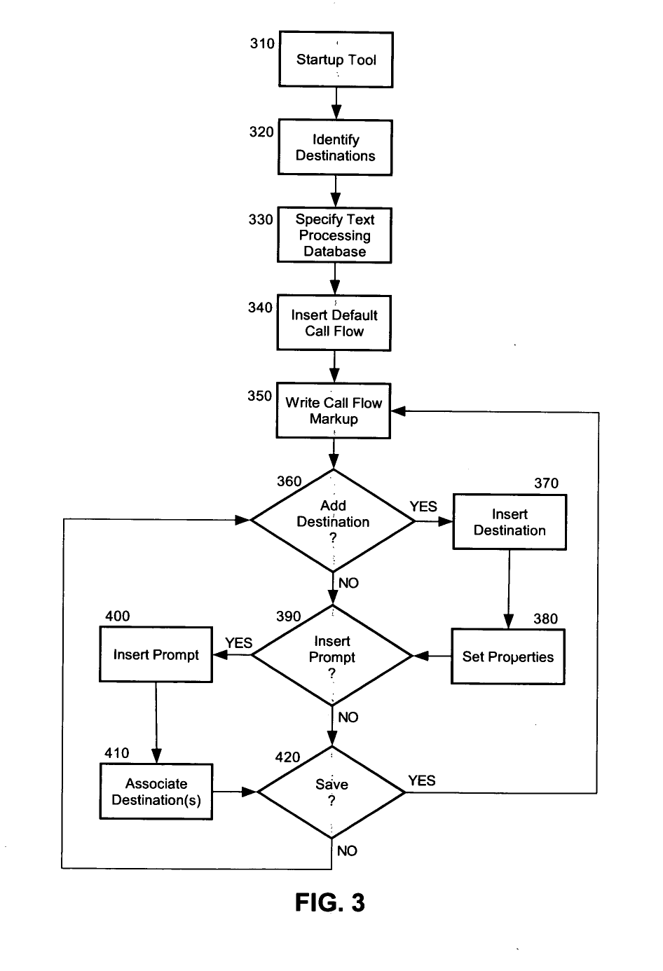

More particularly, FIG. 3 is a flow chart illustration a process for creating a call routing application in the graphical tool of FIG. 2. Beginning in block 310, the graphical tool can be started, for instance through a wizard. The wizard can prompt the developer to identify the ultimate destinations for the IVR application and in block 320 the destinations for the application can be identified as can a database of language model training data in block 330. Once identified, the graphical tool can establish a communicative coupling to the specified database of language model training data such that the graphical tool can utilize the language model training data when resolving routing in a call routing object in the dynamic call router.

Once the startup portion of the graphical tool has completed, a project can be created along with language model artifacts for building statistical models. The graphical editor can insert a default application flow diagram in block 340 representing reasonable defaults for a call router. The graphical tool further can generate all appropriate application markup automatically in block 350 whenever the call router is saved to disk. In this way, the dynamic call router can be ready to be deployed in an IVR application at any time.

In decision block 360, it can be determined whether it is desired to add a new destination for use in the dynamic call router. If so, the destination can be inserted in block 370 and the properties for the destination can be established in block 380. Likewise, in decision block 390, it can be determined whether it is desired to insert a new call routing object into the dynamic call router. If so, in block 400 the call routing object can be inserted and a prompt can be selected for the call routing object. In block 410 one or more destinations can be associated with one or more responses to the prompt as interpreted by the language model engine. Finally, if in decision block 420 it is determined that the dynamic call router is to be persisted, in block 350 the markup for the graphically depicted call flow can be generated and stored.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A graphical tool for creating a dynamic call router, the graphical tool comprising:
a language model engine;
a call routing object coupled to said language model engine and referencing a call route termination object in a canvas; and,
a call flow palette comprising a plurality of call flow elements configured for arrangement in said canvas.

2. The graphical tool of claim 1, further comprising at least one statement represented graphically in said canvas.

3. The graphical tool of claim 1, wherein said language model engine is a natural language understanding model engine.

4. The graphical tool of claim 1, further comprising a properties view configured to display call routing properties of said call routing object.

5. The graphical tool of claim 4, wherein said call routing properties comprise at least one of a confirmation and disambiguation prompt.

6. The graphical tool of claim 1, further comprising a destinations view configured to display available destinations for linkage to said call routing object in a call route termination object.

7. A method for graphically creating a dynamic call router comprising the step of graphically linking a call routing object to a call route termination object in a canvas of a graphical tool for creating dynamic call routers and graphically specifying routing properties for said call routing object.

8. The method of claim 7, wherein said graphically linking step comprises the step of placing a call routing object in said canvas and identifying at least one call route termination object to which a call is to be routed for a responsive utterance to a prompt associated with said call routing object.

9. The method of claim 7, wherein said step of graphically specifying routing properties comprises the step of specifying at least one of a confirmation prompt for a responsive utterance to an initial prompt provided by said call routing object, and a disambiguation prompt to resolve uncertainties in a selected call route for a responsive utterance to an initial prompt.

10. The method of claim 7, further comprising the step of translating a dynamic call router represented in said canvas into a markup language representation of said dynamic call router and storing said dynamic call router for subsequent use in an interactive voice response (IVR) system.

11. A machine readable storage having stored thereon a computer program for graphically creating a dynamic call router, the computer program comprising a routine set of instructions which when executed by a machine causes the machine to perform the step of graphically linking a call routing object to a call route termination object in a canvas of a graphical tool for creating dynamic call routers and graphically specifying routing properties for said call routing object.

12. The machine readable storage of claim 11, wherein said graphically linking step comprises the step of placing a call routing object in said canvas and identifying at least one call route termination object to which a call is to be routed for a responsive utterance to a prompt associated with said call routing object.

13. The machine readable storage of claim 11, wherein said step of graphically specifying routing properties comprises the step of specifying at least one of a confirmation prompt for a responsive utterance to an initial prompt provided by said call routing object, and a disambiguation prompt to resolve uncertainties in a selected call route for a responsive utterance to an initial prompt.

14. The machine readable storage of claim 11, further comprising an additional set of instructions which when executed by the machine causes the machine to further perform the step of translating a dynamic call router represented in said canvas into a markup language representation of said dynamic call router and storing said dynamic call router for subsequent use in an interactive voice response (IVR) system.
